(19) United States
(12) Patent Application Publication
(10) Pub. No.: US 2026/0208202 A1
(43) Pub. Date: Jul. 23, 2026

(54) GYPSUM GRINDING MILL AND METHOD OF GRINDING GYPSUM

(71) Applicant: UNITED STATES GYPSUM COMPANY, Chicago, IL (US)

(72) Inventors: Christopher R. Nelson, Lindenhurst, IL (US); Naser Aldabaibeh, Homer Glen, IL (US); Mark B. Antosh, Wheeling, IL (US)

(21) Appl. No.: 19/345,968

(22) Filed: Sep. 30, 2025

Related U.S. Application Data
(60) Provisional application No. 63/747,934, filed on Jan. 22, 2025.

(51) Int. Cl. B02C 17/16; B02C 17/18

(52) U.S. Cl. CPC B02C 17/163; B02C 17/1815; B02C 17/189

(57) ABSTRACT

A gypsum grinding mill includes a housing comprising a generally cylindrical side wall, a top wall, and a bottom wall. The generally cylindrical side wall, top wall, and bottom wall define a cavity. A fluidization pad is disposed in the housing and divides the cavity into a grinding chamber and an air chamber. Grinding media is disposed in the grinding chamber and an agitator is positioned within the grinding chamber and includes a rotatable shaft and a plurality of agitator bars extending from the rotatable shaft. A blower is connected to the housing and is configured to deliver air into the air chamber and a heat exchanger disposed between the blower and the housing and is configured to cool the air delivered to the air chamber from the blower.

### CROSS-REFERENCE TO RELATED APPLICATIONS

This application claims priority to US Provisional Patent Application No.63/747,934, entitled “Gypsum Grinding Mill and Method of Grinding Gypsum” and filed March 5, 2025, the entire disclosure of which is hereby incorporated by reference herein.

### FIELD OF THE DISCLOSURE

This disclosure relates generally to apparatuses and methods for grinding gypsum and, more particularly, to high-efficiency apparatuses and methods for grinding gypsum.

### BACKGROUND

In the production of drywall, gypsum and other additives may be dry ground and then added to a gypsum slurry to accelerate set times on a board line. However, in typical gypsum grinding mills, there is excess heat generated during the grinding process, especially if steel balls are used as the grinding media. If the heat generated during the grinding process is too great, water or steam can be released from the gypsum being ground, which can result in poor performance of the ground gypsum as an accelerator.

### BRIEF SUMMARY OF THE DISCLOSURE

In one example gypsum grinding mill, the gypsum grinding mill comprises a housing comprising a generally cylindrical side wall, a top wall disposed at a first end of the generally cylindrical side wall, and a bottom wall disposed at a second end of the generally cylindrical side wall, opposite the first end, the generally cylindrical side wall, the top wall, and the bottom wall defining a cavity. A fluidization pad is disposed in the housing and divides the cavity into a grinding chamber and an air chamber. A grinding media is disposed in the grinding chamber and an agitator is positioned within the grinding chamber and comprises a rotatable shaft extending generally longitudinally through the grinding chamber and a plurality of agitator bars extending from the rotatable shaft. A blower is connected to the housing and is configured to deliver air into the air chamber and a heat exchanger is disposed between the blower and the housing and is configured to cool the air delivered to the air chamber from the blower.

In one implementation, the fluidization pad comprises a porous sintered metal.

In another implementation, the fluidization pad comprises: a first perforated plate; a second perforated plate spaced apart from the first perforated plate; and a fluidization media disposed between the first perforated plate and the second perforated plate.

In another implementation, a product discharge port is formed in the generally cylindrical side wall and is configured to discharge a ground gypsum product from the grinding chamber.

In another implementation, the product discharge port is positioned approximately midway between the top wall and the bottom wall.

In another implementation, the grinding media comprises a plurality of steel balls.

In another implementation, each of the plurality of agitator bars comprises a first portion that extends generally radially from the rotatable shaft and a second portion that extends generally perpendicular to the first portion.

In another implementation, the top wall comprises an input port configured to receive an unground gypsum material.

In another implementation, a feed conveyor is in communication with the input port and is configured to provide the unground gypsum material into the grinding chamber through the input port.

In another implementation, an output port is formed in the top wall and a classifier is in communication with the output port.

In another implementation, a dust collector is in communication with the classifier.

In another implementation, the grinding chamber has a grinding chamber volume and the air chamber has an air volume that is less than the grinding chamber volume.

In one example method of grinding gypsum, the method comprises: providing a grinding media to a grinding chamber of a housing of a gypsum grinding mill, the housing comprising a generally cylindrical side wall, a top wall disposed at a first end of the generally cylindrical side wall, and a bottom wall disposed at a second end of the generally cylindrical side wall, opposite the first end; providing an unground gypsum material to the grinding chamber; rotating an agitator within the grinding chamber, the agitator comprising a rotatable shaft extending generally longitudinally through the grinding chamber and a plurality of agitator bars extending from the rotatable shaft; fluidizing the unground gypsum material by flowing air from a blower, through a heat exchanger configured to cool the air from the blower, into an air chamber of the housing, and through a fluidization pad in the housing and into the grinding chamber; and discharging a ground gypsum product from the grinding chamber through a product discharge port formed in the generally cylindrical side wall of the housing.

In one implementation, the grinding media comprises a plurality of steel balls.

In another implementation, the unground gypsum material is provided to the grinding chamber through an input port formed in the top wall of the housing via a feed conveyor.

In another implementation, the agitator is rotated to have a grinding tip speed between 400 feet/min and 600 feet/min.

In another implementation, each of the plurality of agitator bars comprises a first portion that extends generally radially from the rotatable shaft and a second portion that extends generally perpendicular to the first portion.

In another implementation, the fluidization pad comprises: (a) a porous sintered metal; or (b) a first perforated plate, a second perforated plate spaced apart from the first perforated plate, and a fluidization media disposed between the first perforated plate and the second perforated plate.

In another implementation, the product discharge port is positioned approximately midway between the top wall and the bottom wall.

In another implementation, the air is flowed through the fluidization pad and into the grinding chamber at between 10 CFM per ft² and 20 CFM per ft².

### BRIEF DESCRIPTION OF THE DRAWINGS

FIG. 1 illustrates a front view of an example gypsum grinding mill;

FIG. 2 illustrates a perspective view of a portion of the gypsum grinding mill of FIG. 1;

FIG. 3 illustrates a cross-sectional view of the portion of the gypsum grinding mill of FIG. 2, taken along line 3-3 in FIG. 2;

FIG. 4 illustrates a top perspective view of an example fluidization pad of the gypsum grinding mill in FIG. 1;

FIG. 5 illustrates a bottom perspective view of the fluidization pad of FIG. 4;

FIG. 6 illustrates a cross-sectional view of the fluidization pad of FIG. 4, taken along line 6-6 in FIG. 4;

FIG. 7 illustrates a perspective view of an example agitator of the gypsum grinding mill in FIG. 1; and

FIG. 8 illustrates a flow diagram of an example method of grinding gypsum.

### DETAILED DESCRIPTION

The example gypsum grinding mill and method of grinding gypsum disclosed herein improves upon the prior art. The example gypsum grinding mill and method of grinding gypsum use cooled air provided to and circulated through a grinding chamber to fluidize the gypsum being ground. The cooled air keeps temperatures and moisture down by moving air through the grinding chamber. A fluidization pad is secured in a housing of the grinding mill, which divides the housing into the grinding chamber and an air chamber. Cooled air from a blower is cooled by a heat exchanger, and the cooled air from the heat exchanger is provided to the air chamber. The cooled air in the air chamber is then fluidized by the fluidization pad and flowed into the grinding chamber during the grinding process, which can cool the grinding media, cool and dry the gypsum so it does not agglomerate, and prevent the gypsum from calcining. This can allow for an economical grinding mill with a small footprint that can be used in board line manufacture as a continuous process to improve the set time of wall board, which can increase the strength of drywall produced with the ground gypsum and allow the board line to be run at a faster line speed.

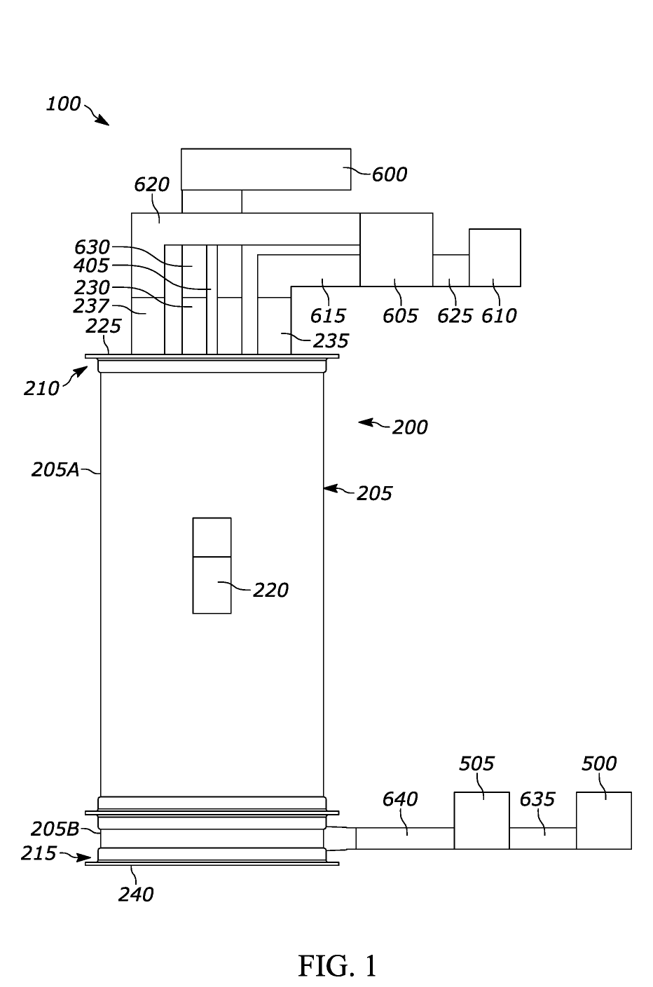

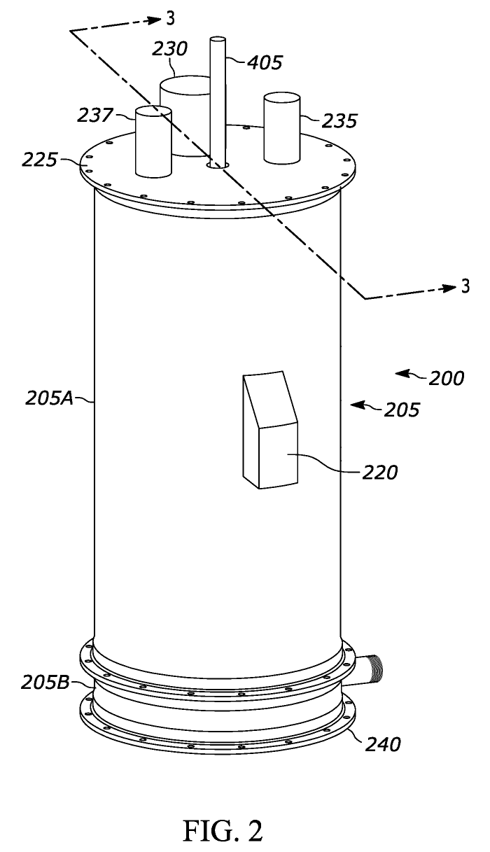

Referring to FIGS. 1-3, an example gypsum grinding mill 100 generally includes a housing 200 and a fluidization pad 300 disposed in housing 200. The fluidization pad 300 divides a cavity 250 of housing 200 into a grinding chamber 255 and an air chamber 260. An agitator 400 and a grinding media 265 are positioned within grinding chamber 255. A blower 500 is connected to housing 200 and configured to deliver air into air chamber 260. A heat exchanger 505 is disposed between blower 500 and housing 200 and configured to cool the air delivered to air chamber 260 from blower 500. In one implementation, grinding media 265 can be a plurality of steel balls and can fill between approximately 25% to approximately 75% of grinding chamber 255.

In the implementation shown, housing 200 of gypsum grinding mill 100 includes a generally cylindrical side wall 205, a top wall 225 disposed at a first end 210 of generally cylindrical side wall 205, and a bottom wall 240 disposed at a second end 215 of generally cylindrical side wall 205, opposite first end 210. Generally cylindrical side wall 205, top wall 225, and bottom wall 240 define cavity 250 within housing 200.

In the implementation shown, generally cylindrical side wall 205 has a single wall configuration. In other implementations, generally cylindrical side wall 205 can have a double wall configuration and can include an inner sleeve (e.g., of hardened steel) and an outer sleeve (e.g., of stainless steel) positioned adjacent to and surrounding the inner sleeve. A product discharge port 220 can be formed in generally cylindrical side wall 205 and can be used to discharge a ground gypsum product from grinding chamber 255. In some implementations, multiple product discharge ports could be formed in generally cylindrical side wall 205 at different heights to change the bed height and residence time of the gypsum to be ground. A clean-out port (not shown) can also be formed in generally cylindrical side wall 205, towards the bottom of generally cylindrical side wall 205, and the product discharge port(s) and/or clean-out port can be opened and closed as necessary with valves. In the implementation shown, product discharge port 220 is positioned approximately midway between top wall 225 and bottom wall 240, but could be positioned higher or lower depending on an anticipated fill level of grinding chamber 255 with grinding media 265 and unground gypsum material.

Top wall 225 of housing 200 is formed generally as a disc and can be connected to a first flange 270 at first end 210 of generally cylindrical side wall 205, for example, with threaded members or other fastening means. Similarly, bottom wall 240 of housing 200 can be formed generally as a disc and can be connected to a second flange 275 at second end 215 of generally cylindrical side wall 205, for example, with threaded members or other fastening means. In some implementations, top wall 225 can include an input port 230 that is configured to receive an unground gypsum material. A feed conveyor 600, either as part of gypsum grinding mill 100 or separate from gypsum grinding mill 100, can be in communication with input port 230 through an input plenum 630 and can be configured to provide the unground gypsum material into grinding chamber 255 through input port 230. The feed rate of unground gypsum material into grinding chamber 255 can be determined based on line speed, unground gypsum material purity, slurry temperature, and additives used. In some implementations, the unground gypsum material can be provided into grinding chamber 255 at approximately 5 pounds to 30 pounds/minute usage rate. An output port 235 can also be formed in top wall 225 and can be in communication with a classifier 605, which can be part of gypsum grinding mill 100 or separate from gypsum grinding mill 100, via an output plenum 615. Classifier 605 (e.g., a cyclone classifier, a ball mill classifier, etc.) can be configured to separate particles entrained in the air exiting grinding chamber 255 through output port 235 into course and fine particles based on their size, shape, or density. Course particles (e.g., particles approximately 20 microns or larger) can be returned to grinding chamber 255 to be reground through a return plenum 620, which is in communication with grinding chamber 255 through a return port 237 formed in top wall 225 of housing 200. Fine particles (e.g., particles approximately 5 microns or smaller) can be sent to a dust collector 610, which is in communication with classifier 605 through a dust collection plenum 625.

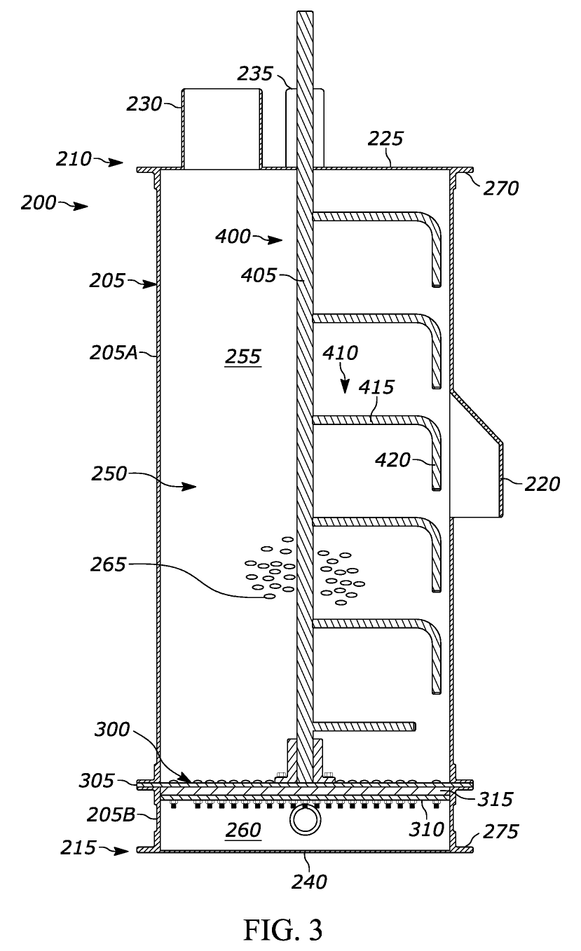

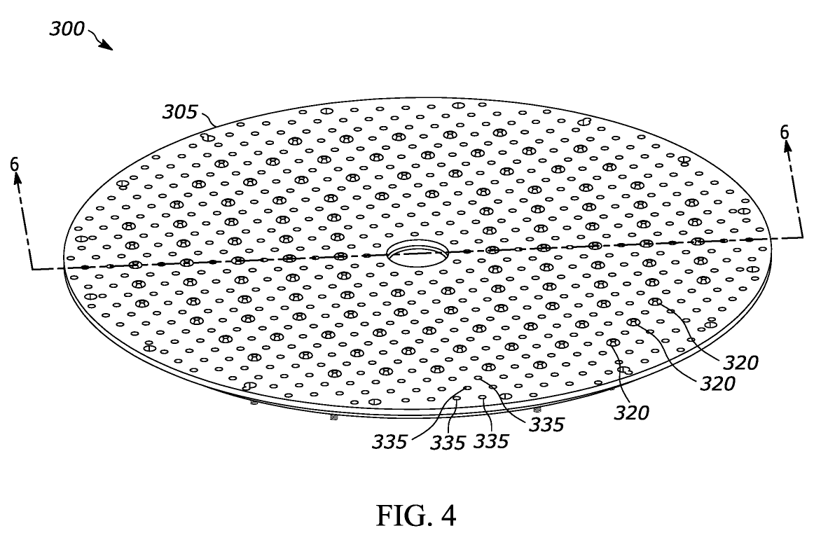

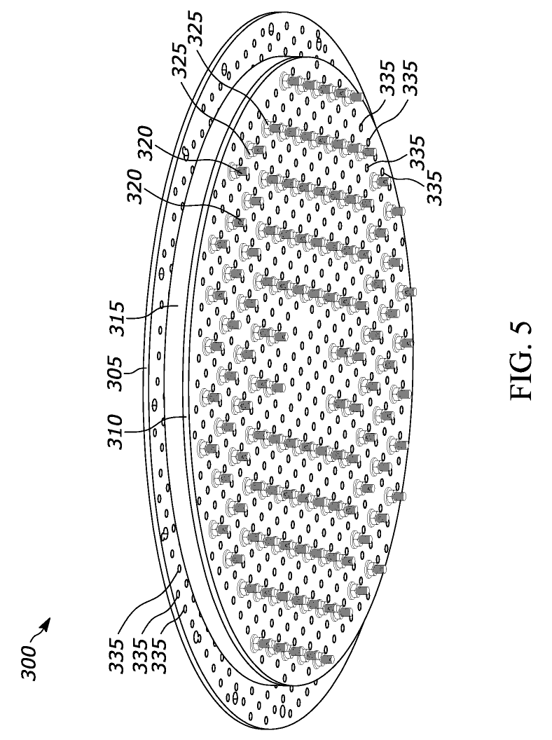

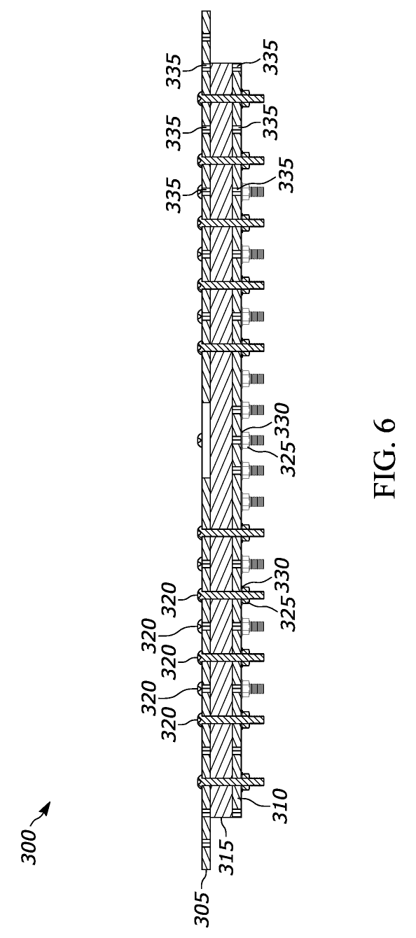

Referring to FIGS. 3-6, fluidization pad 300 can be disposed in housing 200, can divide cavity 250 of housing 200 into grinding chamber 255 and air chamber 260, and can be configured to evenly distribute air passing from air chamber 260 to grinding chamber 255. In some implementations, air chamber 260 can have an air chamber volume that is less than a grinding chamber volume of grinding chamber 255 (e.g., a grinding chamber volume to air chamber volume ratio of approximately 10:1). Air chamber 260 acts as a manifold to direct the flow of the air. In some implementations, the highest pressure drop can be at fluidization pad 300, which can allow the air to be distributed evenly, while preventing fluidization. For example, the pressure drop can be approximately 5-9 psi at an air flow of approximately 10-20 CFM and the air velocity can be kept even across the bottom of fluidization pad 300. Grinding chamber 255 should be large enough to handle the throughput of the fluidized gypsum with some space to allow particles to drop out. In addition, in some implementations, the residence time of the gypsum material in grinding chamber 255 can be approximately 5-60 seconds. In the implementation shown, fluidization pad 300 includes a first perforated plate 305, a second perforated plate 310 spaced apart from first perforated plate 305, and a fluidization media 315 disposed between first perforated plate 305 and second perforated plate 310. First perforated plate 305 and second perforated plate 310 are configured to provide structural support for fluidization pad 300 and can be formed of hardened steel plates having a plurality of holes 335 to allow the passage of air. In some implementations, first perforated plate 305 and second perforated plate 310 can be in a range between approximately 40% to approximately 70% open and, preferably, are approximately 65% open. Fluidization media 315 can be any media that allows the passage of air and that can disperse the air that passes through fluidization media 315, such as a compressed silica needled mat, porous fiber mat, woven stainless steel media, or other suitable material. A plurality of button head bolts 320 can extend through holes in first perforated plate 305 and second perforated plate 310 and, with nuts 325 and washers 330, can compress fluidization media 315 between first perforated plate 305 and second perforated plate 310 and secure first perforated plate 305, second perforated plate 310, and fluidization media 315 together. In other implementations, rather than a fluidization media between opposing perforated plates, fluidization pad 300 can be a porous sintered metal.

As can be seen in FIG. 3, in the particular implementation shown, generally cylindrical side wall 205 of housing 200 includes a first portion 205A and a second portion 205B. First portion 205A of generally cylindrical side wall 205, fluidization pad 300, and top wall 225 define grinding chamber 255, while second portion 205B of generally cylindrical side wall 205, fluidization pad 300, and bottom wall 240 define air chamber 260. A portion of fluidization pad 300 can extend and be secured between first portion 205A and second portion 205B to secure fluidization pad 300 within housing 200 and form grinding chamber 255 and air chamber 260. For example, in the implementation shown, first perforated plate 305 has a diameter that is greater than a diameter of second perforated plate 310 and greater than an inner diameter of generally cylindrical side wall 205, such that first perforated plate 305 extends between first portion 205A and second portion 205B and is secured between flanges in first portion 205A and second portion 205B, for example, with threaded members or other fastening means. In other implementations, generally cylindrical side wall 205 could be a single, unitary part and fluidization pad 300 can be secured to an inner surface of generally cylindrical side wall 205 with a connector, a bracket, or other fastening means.

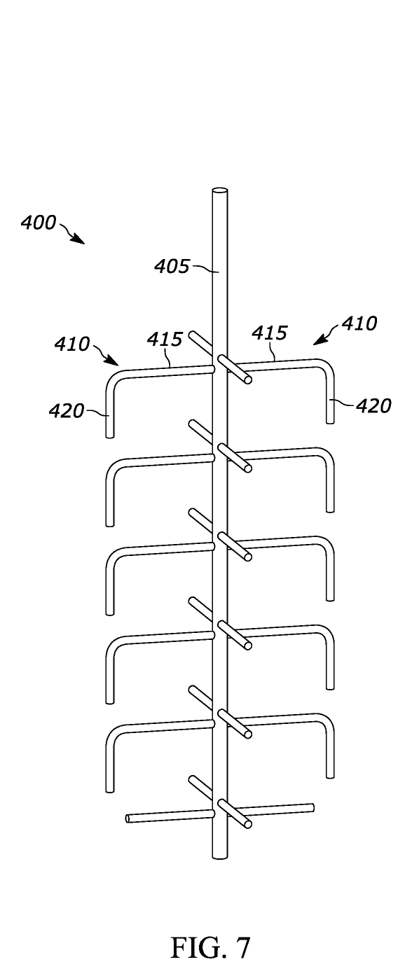

Referring to FIGS. 3 and 7, in the implementation shown, agitator 400 generally includes a rotatable shaft 405 that extends longitudinally through grinding chamber 255 and outside of housing 200 through a hole in top wall 225. Agitator 400 can be coupled to a drive device (e.g., an electric motor, etc.) that can be configured to rotate agitator 400. A plurality of agitator bars 410 extend from rotatable shaft 405 and each of plurality of agitator bars 410 has a first portion 415 that extends radially from rotatable shaft 405 and a second portion 420 that extends perpendicular to first portion 415 and generally parallel to rotatable shaft 405. In the implementation shown, second portion 420 extends downward (e.g., from first portion 415 toward bottom wall 240). In other implementations, second portion 420 could extend upward (e.g., from first portion 415 toward top wall 225), each of the plurality of agitator bars 410 could include only first portion 415, or agitator 400 could include a plurality of discs that extend from rotatable shaft 405, instead of or in addition to plurality of agitator bars 410. Other configurations of agitator 400 are possible.

Referring back to FIG. 1, blower 500 and heat exchanger 505 are configured to transport air to air chamber 260 at a relatively high volume, a relatively low pressure, and at a reduced temperature (e.g., between 68°F and 100°F). In the implementation shown, blower 500 supplies air to heat exchanger 505 via a first air plenum 635. Heat exchanger 505 (e.g., an intercooler) then cools the air received from blower 500 and supplies the cooled air to air chamber 260 via a second air plenum. Cooling the air supplied to air chamber 260 and distributing the cooled air through fluidization pad 300 into grinding chamber 255 keeps the temperature in grinding chamber 255 down (e.g., between approximately 110°F and 130°F), which prevents the gypsum product, grinding media 265, and agitator 400 from overheating. In addition, the flow of cooled air through grinding chamber 255 reduces the moisture released from the gypsum product, which dries the gypsum product being ground and removes moisture so the gypsum product does not agglomerate.

In other implementations, gypsum grinding mill 100 can also include one or more of a rotameter (not shown) between blower 500 and air chamber 260 to measure the air flow provided to air chamber 260, a magnehelic (not shown) positioned between air chamber 260 and the atmosphere to measure differential pressure between atmospheric pressure and the pressure in air chamber 260, a pressure relief valve (not shown) positioned between blower 500 and air chamber 260, and/or a flow valve (e.g., a glove valve) (not shown) to adjust the flow of cooled air to air chamber 260.

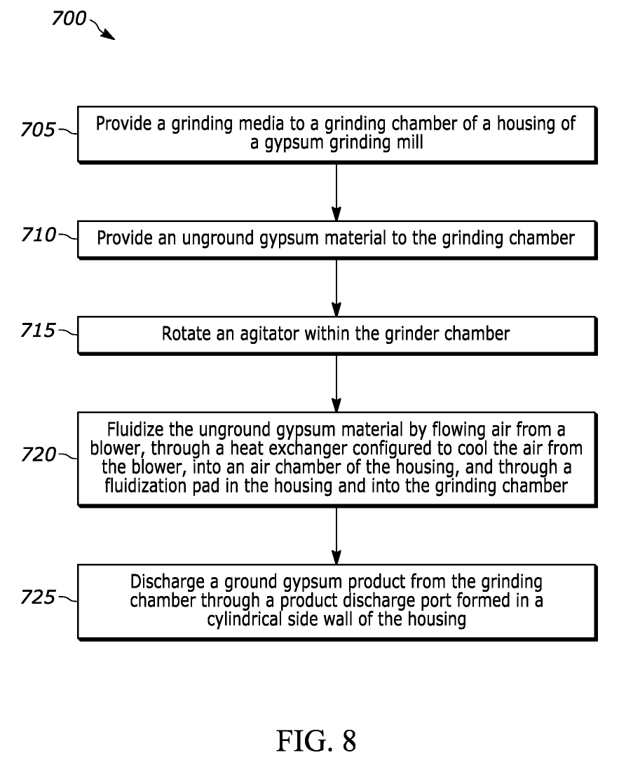

Referring to FIG. 8, an example method 700 of grinding gypsum is illustrated. At Step 705 of method 700, a grinding media (e.g., grinding media 265), which in some implementations can be a plurality of steel balls, is provided to a grinding chamber (e.g., grinding chamber 255) of a housing (e.g., housing 200) of a gypsum grinding mill (e.g., gypsum grinding mill 100). In some implementations, the housing will include a generally cylindrical side wall (e.g., generally cylindrical side wall 205), a top wall (e.g., top wall 225) disposed at a first end (e.g., first end 210) of the generally cylindrical side wall, and a bottom wall (e.g., bottom wall 240) disposed at a second end (e.g., second end 215) of the generally cylindrical side wall, opposite the first end. The grinding chamber can be filled in a range between approximately 25% to approximately 75% with the grinding media.

At Step 710, an unground gypsum material (e.g., a gypsum material having particles less than approximately 100 microns and a moisture level of less than approximately 0.1%) is provided to the grinding chamber of the housing. In some implementations, the unground gypsum material can be provided to the grinding chamber through an input port (e.g., input port 230) that is formed in the top wall of the housing and can be supplied via a feed conveyor (e.g., feed conveyor 600). The feed rate of unground gypsum material into the grinding chamber can be determined based on line speed, unground gypsum material purity, slurry temperature, and additives used. In some implementations, the unground gypsum material can be provided into the grinding chamber at approximately 5 pounds to 30 pounds/minute usage rate.

At Step 715, an agitator (e.g., agitator 400) located with the grinding chamber is rotated (e.g., by an electric motor, etc.), for example, to have a griding tip speed between approximately 400 feet/min and approximately 600 feet/min. The rotation of the agitator in the grinding chamber moves/displaces the grinding media, which grinds the unground gypsum material. In some implementations, the agitator can include a rotatable shaft (e.g., rotatable shaft 405) that extends longitudinally through the grinding chamber and a plurality of agitator bars (e.g., plurality of agitator bars 410) that extend from the rotatable shaft. In some implementations, each of the agitator bars can have a first portion (e.g., first portion 415) that extends generally radially from the rotatable shaft and a second portion (e.g., second portion 420) that extends generally perpendicular to the first portion and generally parallel to the rotatable shaft.

At Step 720, the unground gypsum material in the grinding chamber is fluidized by flowing air from a blower (e.g., blower 500) through a heat exchanger (e.g., heat exchanger 505) that is configured to cool the air from the blower (e.g., to a temperature between 68°F and 100°F) and from the heat exchanger into an air chamber (e.g., air chamber 260) of the housing. Air from the air chamber is then flowed through a fluidization pad (e.g., fluidization pad 300) in the housing from the air chamber and into the grinding chamber (e.g., at between approximately 10 CFM per ft² and approximately 20 CFM per ft²) to cool (e.g., to between approximately 110°F and 130°F) and dry the gypsum being ground. In some implementations, the fluidization pad can include a first perforated plate (e.g., first perforated plate 305), a second perforated plate (e.g., second perforated plate 310) spaced apart from the first perforated plate, and a fluidization media (e.g., fluidization media 315) disposed between the first perforated plate and the second perforated plate. The first and second perforated plates can be hardened steel plates that provide structural support to the fluidization pad and that are 40-70% open. The fluidization media can be a compressed silica needled mat, a porous fiber mat, a woven stainless steel media, or other suitable material.

At Step 725, a ground gypsum product (e.g., gypsum having a particle size between approximately 5 micron and approximately 10 microns) is discharged from the grinding chamber through a product discharge port (e.g., product discharge port 220) formed in the generally cylindrical side wall of the housing. In some implementations, the product discharge port can be positioned approximately midway between the top wall and the bottom wall of the housing, but can be positioned at other locations higher or lower than the midpoint of generally cylindrical side wall depending on the anticipated fill of the grinding chamber. In other implementations, multiple product discharge ports can be formed in the generally cylindrical side wall at different heights to change the bed height and residence time of the gypsum to be ground. A clean-out port (not shown) can also be formed towards the bottom of the generally cylindrical side wall, and the product discharge port(s) and/or clean-out port can be opened and closed as necessary with valves.

In other implementations, the method could also include receiving an airflow with entrained ground gypsum material through an output port (e.g., output port 235) in the top wall and directing the airflow to a classifier (e.g., classifier 605), which can separate particles entrained in the airflow exiting the grinding chamber 255 into course and fine particles based on their size, shape, or density. Course particles from the classifier can then be returned to the grinding chamber through a return port (e.g., return port 237) in the top wall and fine particles can be sent to a dust collector (e.g., dust collector 610).

The figures and description provided herein depict and describe examples for purposes of illustration only. One skilled in the art will readily recognize from the foregoing discussion that alternative embodiments of the components illustrated herein may be employed without departing from the principles described herein. Thus, upon reading this disclosure, those of skill in the art will appreciate still additional alternative structural and functional designs. Thus, while particular examples and applications have been illustrated and described, it is to be understood that the disclosed examples are not limited to the precise construction and components disclosed herein. Various modifications, changes, and variations, which will be apparent to those skilled in the art, may be made in the arrangement, operation and details of the methods and components disclosed herein without departing from the spirit and scope defined in the appended claims.

What is claimed is:

1. A gypsum grinding mill, comprising:
a housing comprising a generally cylindrical side wall, a top wall disposed at a first end of the generally cylindrical side wall, and a bottom wall disposed at a second end of the generally cylindrical side wall, opposite the first end, the generally cylindrical side wall, the top wall, and the bottom wall defining a cavity;
a fluidization pad disposed in the housing, the fluidization pad dividing the cavity into a grinding chamber and an air chamber;
an agitator positioned within the grinding chamber, the agitator comprising a rotatable shaft extending generally longitudinally through the grinding chamber and a plurality of agitator bars extending from the rotatable shaft;
a grinding media disposed in the grinding chamber;
a blower connected to the housing and configured to deliver air into the air chamber; and
a heat exchanger disposed between the blower and the housing and configured to cool the air delivered to the air chamber from the blower.

2. The gypsum grinding mill of claim 1, wherein the fluidization pad comprises a porous sintered metal.

3. The gypsum grinding mill of claim 1, wherein the fluidization pad comprises: a first perforated plate; a second perforated plate spaced apart from the first perforated plate; and a fluidization media disposed between the first perforated plate and the second perforated plate.

4. The gypsum grinding mill of claim 1, comprising a product discharge port formed in the generally cylindrical side wall and configured to discharge a ground gypsum product from the grinding chamber.

5. The gypsum grinding mill of claim 4, wherein the product discharge port is positioned approximately midway between the top wall and the bottom wall.

6. The gypsum grinding mill of claim 1, wherein the grinding media comprises a plurality of steel balls.

7. The gypsum grinding mill of claim 1, wherein each of the plurality of agitator bars comprises a first portion that extends generally radially from the rotatable shaft and a second portion that extends generally perpendicular to the first portion.

8. The gypsum grinding mill of claim 1, wherein the top wall comprises an input port configured to receive an unground gypsum material.

9. The gypsum grinding mill of claim 8, comprising a feed conveyor in communication with the input port and configured to provide the unground gypsum material into the grinding chamber through the input port.

10. The gypsum grinding mill of claim 1, comprising: a output port formed in the top wall; and a classifier in communication with the output port.

11. The gypsum grinding mill of claim 10, comprising a dust collector in communication with the classifier.

12. The gypsum grinding mill of claim 1, wherein the grinding chamber has a grinding chamber volume and the air chamber has an air volume that is less than the grinding chamber volume.

13. A method of grinding gypsum, comprising:
providing a grinding media to a grinding chamber of a housing of a gypsum grinding mill, the housing comprising a generally cylindrical side wall, a top wall disposed at a first end of the generally cylindrical side wall, and a bottom wall disposed at a second end of the generally cylindrical side wall, opposite the first end;
providing an unground gypsum material to the grinding chamber;
rotating an agitator within the grinding chamber, the agitator comprising a rotatable shaft extending generally longitudinally through the grinding chamber and a plurality of agitator bars extending from the rotatable shaft;
fluidizing the unground gypsum material by flowing air from a blower, through a heat exchanger configured to cool the air from the blower, into an air chamber of the housing, and through a fluidization pad in the housing and into the grinding chamber; and
discharging a ground gypsum product from the grinding chamber through a product discharge port formed in the generally cylindrical side wall of the housing.

14. The method of claim 13, wherein the grinding media comprises a plurality of steel balls.

15. The method of claim 13, wherein the unground gypsum material is provided to the grinding chamber through an input port formed in the top wall of the housing via a feed conveyor.

16. The method of claim 13, wherein the agitator is rotated to have a grinding tip speed between 400 feet/min and 600 feet/min.

17. The method of claim 13, wherein each of the plurality of agitator bars comprises a first portion that extends generally radially from the rotatable shaft and a second portion that extends generally perpendicular to the first portion.

18. The method of claim 13, wherein the fluidization pad comprises: (a) a porous sintered metal; or (b) a first perforated plate; a second perforated plate spaced apart from the first perforated plate; and a fluidization media disposed between the first perforated plate and the second perforated plate.

19. The method of claim 13, wherein the product discharge port is positioned approximately midway between the top wall and the bottom wall.

20. The method of claim 13, wherein the air is flowed through the fluidization pad and into the grinding chamber at between 10 CFM per ft² and 20 CFM per ft².
